(19) United States
(12) Patent Application Publication
(10) Pub. No.: US 2024/0281699 A1
(43) Pub. Date: Aug. 22, 2024

(54) MANAGEMENT OF DRIFTED RECORDS IN MACHINE LEARNING

(71) Applicant: INTERNATIONAL BUSINESS MACHINES CORPORATION, Armonk, NY (US)

(72) Inventors: Prem Piyush GOYAL, Hyderabad (IN); Harivansh KUMAR, Hyderabad (IN); Manish Anand BHIDE, Hyderabad (IN)

(21) Appl. No.: 18/170,307

(22) Filed: Feb. 16, 2023

(51) Int. Cl. G06N 20/00

(52) U.S. Cl. CPC G06N 20/00

(57) ABSTRACT

A machine learning model is trained. A set of drifted records are determined during payload time of the machine learning model. The determined set of drifted records are pruned to use in retraining of the machine learning model.

### BACKGROUND

### 1. Field

Embodiments relate to a method, system, and computer program product for the management of drifted records in machine learning.

### 2. Background

A machine learning (ML) model is a mathematical model that is used to predict outcomes from data. The machine learning model is trained on a dataset, where the dataset is a collection of data that includes both the input data (such as features) and the output data (such as labels). The machine learning model is then able to generate predictions on new data that has not been seen before.

For example, a machine learning model for computer vision may be able to identify cars and pedestrians in a real-time video. Another example may be a machine learning model for natural language processing that may be able to translate words and sentences. Data scientists have created whole families of machine learning models for many different uses. Many such machine learning models have been implemented via neural networks.

Machine learning may be described in many ways including as a type of optimization. Optimization problems deal with finding the best, or “optimal” solution to some type of problem. In order to find the optimal solution, a way of measuring the quality of a solution is needed. This is done via what is known as an objective function. This objective function, taking data and model parameters as arguments, may be evaluated to return a number. A solution that employs machine learning may include some parameters that may be changed, and such solutions may be used to find values for these parameters that either maximize or minimize the number returned by the objective function.

Training data is also known as training dataset or learning set, and the training data is used to train a machine learning model. Training data is an essential component of every machine learning model and helps a machine learning model to make accurate predictions or perform a desired task. A machine learning model analyzes the training data repeatedly to understand its characteristics and adjust itself for better performance. The machine learning model is applied to production data at deployment to generate inferences.

In machine learning, model drift means that the machine learning model has become less and less accurate over time due to changes in the statistical properties of the input features, target variable, or relationships among variables. While the data on which the machine learning model is trained is called training data or source data, the data on which the model is trying to predict is called serving data or target data, and the prediction is performed at production time. The training or source data distributions may be different from the serving or target data distributions.

Machine learning may also be used to perform payload logging, feedback logging, and to measure performance accuracy, runtime bias detection, drift detection, and auto-debias function in programming systems such as IBM® Watson OpenScale (IBM and all IBM-based trademarks and logos are trademarks or registered trademarks of International Business Machines Corporation and/or its affiliates).

### SUMMARY

Provided are a method, system, and computer program product in which training is performed for a machine learning model. A set of drifted records are determined during payload time of the machine learning model. The determined set of drifted records are pruned and used in retraining of the machine learning model.

In further embodiments, a first record flagged as drifted is received, the first record belonging to an existing category or interval which has a number of records smaller than a predetermined threshold in a training data of the machine learning model. A model confidence distribution is obtained for the first record at training time of the machine learning model. A determination is made as to whether the first record is an outlier with respect to the model confidence distribution by using a model confidence of the first record at the payload time of the machine learning model. An outputting is performed of the first record as a relabeling candidate based on the determination.

In additional embodiments, second records flagged as drifted is received, the second records belonging to a new category or interval which is not seen in the training data of the machine learning model. A feature importance vector of input features of the machine learning model is obtained. A selection is made of a proportionate number of the second records from each feature, based on the feature importance vector.

In certain embodiments, third records flagged as drifted is received, the third records belonging to an existing category or interval which has a number of records equal to or greater than the predetermined threshold in the training data of the machine learning model. A feature importance vector of input features of the machine learning model is obtained. The third records are selected or ignored based on the feature importance vector.

In further embodiments, the set of drifted records result at least from production datasets at payload time having different characteristics from training datasets during the training.

In yet further embodiments, the set of drifted production records at payload time are pruned for relabeling with categories or intervals having an occurrence less than a predetermined threshold in training data by using a model confidence distribution.

In additional embodiments, drifted production records at payload time are pruned for relabeling with unseen categories or ranges in training data by using a feature importance of the machine learning model.

### BRIEF DESCRIPTION OF THE DRAWINGS

Referring now to the drawings in which like reference numbers represent corresponding parts throughout:

FIG. 1 illustrates a block diagram of a computing environment for the management of drifted records in machine learning implementations, in accordance with certain embodiments.

FIG. 2 illustrates a block diagram that shows exemplary inputs to a drifted record management application, in accordance with certain embodiments.

FIG. 3 illustrates a block diagram that shows different categories of drifted records, in accordance with certain embodiments.

FIG. 4 illustrates a block diagram that shows the management of new categories or intervals, in accordance with certain additional embodiments.

FIG. 5 illustrates a block diagram that shows the managing of categories that are less than a threshold percentage of records at training time, in accordance with certain additional embodiments.

FIG. 6 illustrates a block diagram that shows the managing of categories that are greater than a threshold percentage of records at training time, in accordance with certain additional embodiments.

FIG. 7 illustrates a flowchart that shows operations for the management of drifted records, in accordance with certain additional embodiments.

FIG. 8 illustrates a flowchart that shows additional operations for the management of drifted records, in accordance with certain additional embodiments.

FIG. 9 illustrates a flowchart that shows further operations for the management of drifted records, in accordance with certain additional embodiments.

FIG. 10 illustrates a computing environment in which certain components of FIG. 1 may be implemented, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

A data scientist creates a machine learning model based on training data. The machine learning model generates predictions on the production data The production data may contain outliers on different features and may also face distribution shift. These issues may be detected by various model monitoring systems, such as, OpenScale*. The data scientist may export all the records flagged by the model monitoring system, to send for human labelling and then retrain the machine learning model by using the additional labelled data. The retraining of the machine learning model may improve the performance of the machine learning model.

The data scientist may be aware that the machine learning model is not performing well because of the drift issues flagged by the model monitoring system. Fixing the flagged issues requires the data scientist to go through all the flagged transactions, where the number of such flagged transactions could be in the order of millions. To fix the flagged issues, the data scientist may need to send the flagged transactions corresponding to the flagged issues to a team of humans to manually label them. This is required, to correctly identify the ground truth, and to retrain the model with this additional data. Getting the ground truth by assigning humans to label all the problematic records may not be always be feasible due to the time and expenses involved.

Certain embodiments provide various improvements to machine learning based processing mechanisms to shortlist a minimal subset of records from a large number of drifted records for human labeling, in order to reduce the time and expenses involved and improve the model performance. As a result, the operations of a computational device that implements machine learning based systems are improved. For example, in certain embodiments mechanisms are provided to shortlist drifted production records for human relabeling for categories or intervals having a small occurrence in training data while using the model confidence distribution. In other embodiments mechanisms are provided to shortlist drifted production records for human relabeling with unseen categories or ranges in training data using the feature importance of the machine learning model. Such embodiments improve the operations of a computational device that implements machine learning based mechanisms.

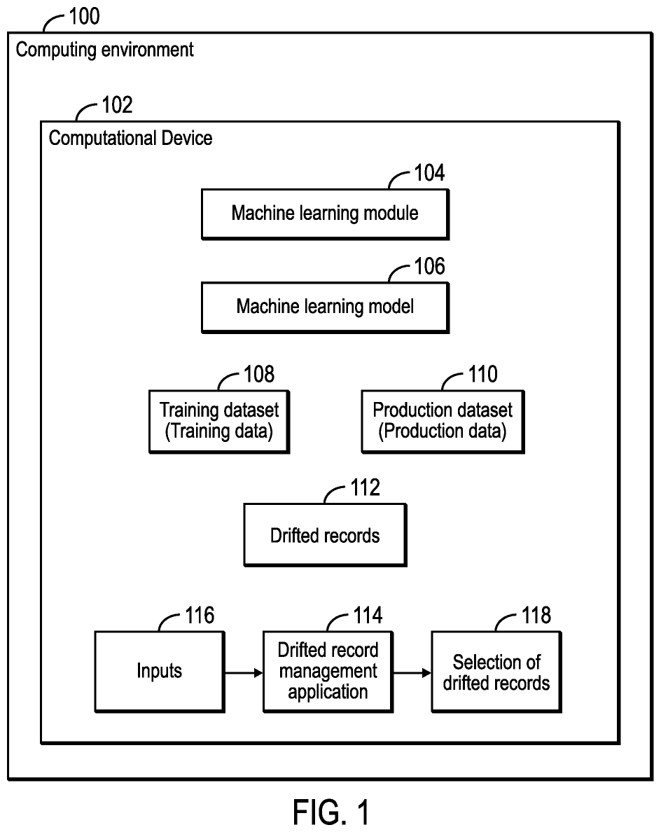

FIG. 1 illustrates a block diagram of a computing environment 100 that includes a computational device 102 for the management of drifted records in machine learning systems, in accordance with certain embodiments.

The computational device 102 may comprise any suitable computational device including those presently known in the art, such as, a personal computer, a workstation, a server, a mainframe, a hand held computer, a palm top computer, a head mounted computer, a telephony device, a network appliance, a blade computer, a processing device, a controller, etc. The computational device 102 may be an element in any suitable network, such as, a storage area network, a wide area network, the Internet, an intranet, etc. In certain embodiments, the computational device 102 may be an element in a cloud computing environment.

The computational device 102 includes a machine learning module 104 that is based on a machine learning model 106, where the machine learning model 106 is trained by a training dataset 108. During payload time (i.e., during the use of the machine learning module 104 for predicting results based on new inputs), production datasets 110 are used. The training dataset 108 may also be referred to as training data and the production dataset 110 as production data.

Existing mechanisms may be used to determine drifted records 112 during the payload time. A drifted record management application 114 takes as input 116 at least the drifted records 112 and other information, and generates a selection of drifted records 118 that are fewer in number than the drifted records 112, for use by a human user in retraining the machine learning model 106 for improved efficacy in the future. In this process, the drifted records 112 are pruned in number to accommodate the number of records the human user can handle for retraining the machine learning model 106.

In certain embodiments, the drifted record management application 114 and the machine learning module 104 may be implemented in software, hardware, firmware, or any combination thereof.

Therefore, FIG. 1 illustrates a computing environment 100 in which a drifted record management application 114 is used to prune drifted records for manual retraining by a human user.

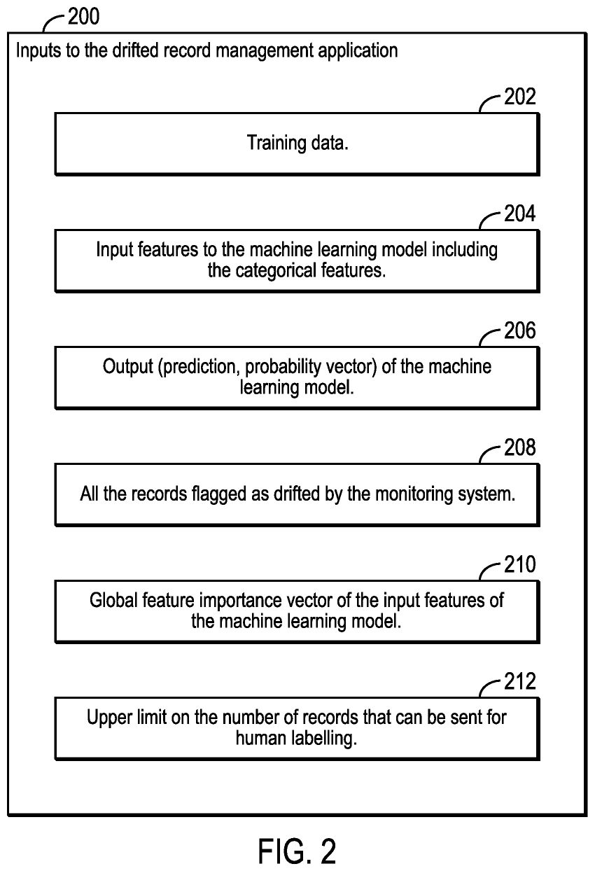

FIG. 2 illustrates a block diagram 200 that shows exemplary inputs to the drifted record management application 114, in accordance with certain embodiments.

The inputs may include training data 202 and input features to the machine learning model including the categorical features (reference numeral 204). Outputs that include the prediction and probability vectors of the machine learning model are also provided as inputs to the drifted record management application (reference numeral 206).

All the records flagged as drifted by an existing model monitoring system are also included as inputs to the drifted record management application (reference numeral 208).

Global feature importance vector of the input features of the machine learning model (reference numeral 210) and an upper limit on the number of records that can be sent for human labelling (reference numeral 212) are also provided as inputs to the drifted record management application 114.

For the purposes of this disclosure, the term “category” is used for a unique value in categorical and encoded features in machine learning, and the term “interval” is used for a bucket or range of values in numerical features in machine learning.

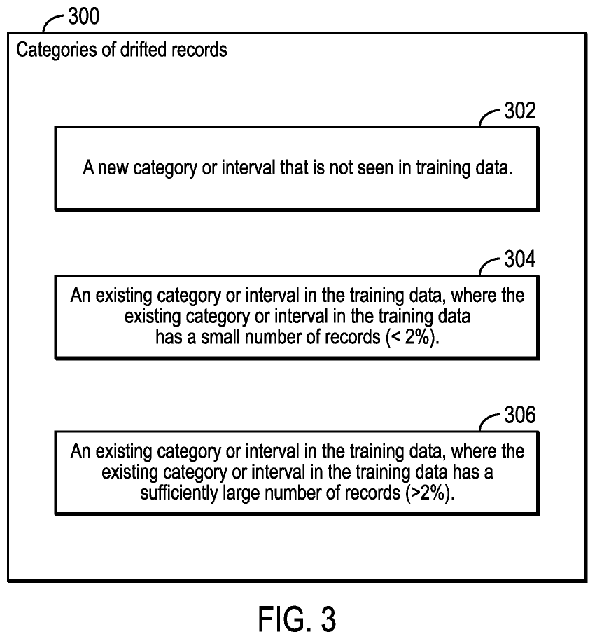

FIG. 3 illustrates a block diagram 300 that shows different categories of drifted records 112, in accordance with certain embodiments.

The three categories of drifted records 112 shown in FIG. 3, include:
(i) A new category or interval that is not seen in training data (reference numeral 302);
(ii) An existing category or interval in the training data, where the existing category or interval in the training data has a small number of records (e.g., <2%) [reference numeral 304]; and
(iii) An existing category or interval in the training data, where the existing category or interval in the training data has a sufficiently large number of records (e.g., >2%) [reference numeral 306].

In FIG. 3, The 2% limit of the threshold for “small” or “large” is an exemplary default value and may be different in other embodiments.

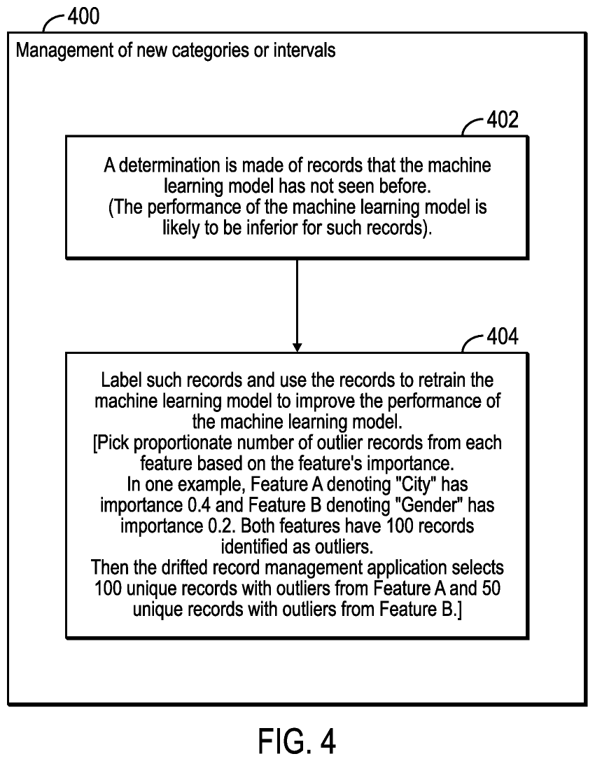

FIG. 4 illustrates a block diagram 400 that shows the management of new categories or intervals, in accordance with certain additional embodiments. The operations shown in FIG. 4 may be performed by the drifted record management application 114 shown in FIG. 1.

For managing new categories or intervals, a determination is made (at block 402) of the records that the machine learning model has not seen before. The performance of the machine learning model is likely to be inferior for such records. By labeling these records (at block 404), and then using these labelled records to retrain the model, the performance of the machine learning model may be improved.

In certain embodiments, a proportionate number of outlier records are selected from each feature based on the feature's importance. For example, the Feature A denoting “City” has importance 0.4 and Feature B denoting “Gender” has importance 0.2. Both features have 100 records identified as outliers (i.e., Feature A has 100 outliers, and Feature B has 100 outliers). Then the drifted record management application 114 selects a hundred unique records with outliers from Feature A, and fifty unique records with outliers from Feature B, to account for the fact that Feature A has twice the importance of Feature B.

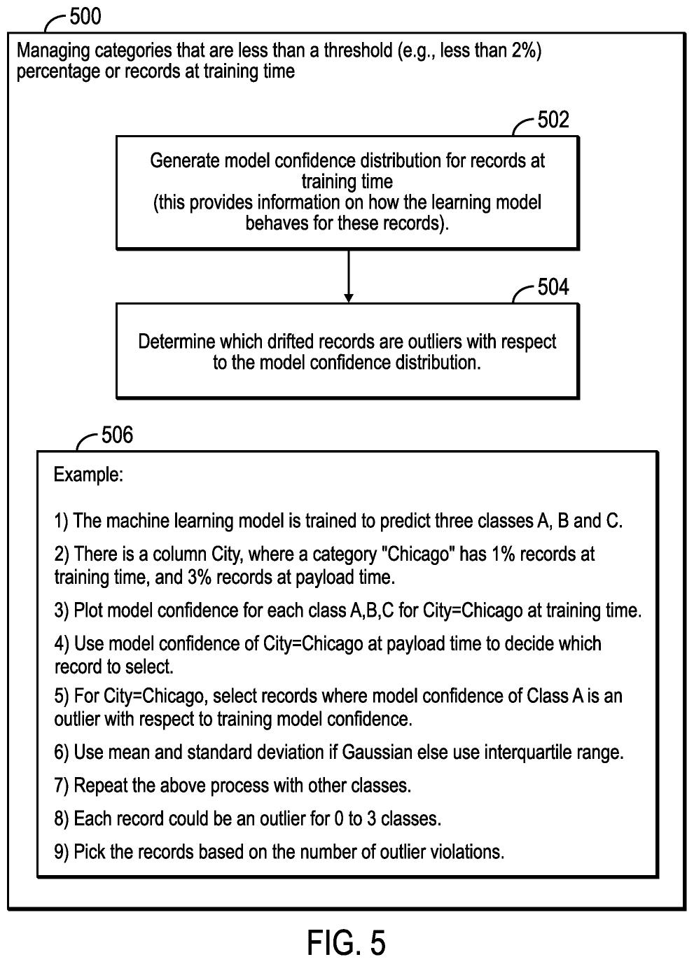

FIG. 5 illustrates a block diagram 500 that shows the managing of categories that are less than a threshold percentage of records at training time, in accordance with certain additional embodiments. The operations shown in FIG. 5 may be performed by the drifted record management application 114 shown in FIG. 1.

FIG. 5 shows embodiments for tackling categories that are less than 2% of records at training time, i.e., there are not enough records. Just performing a random sample of such drifted records and sending the random samples for labeling will not be enough. It is desirable to have a way to measure the impact of such records on the performance of the machine learning model. Also, just selecting records that caused model confidence (probability) to be lower may not suffice because the model confidence distribution for such records may be towards the lower end.

Certain embodiments generate a model confidence distribution for such records at training time (at block 502). This provides information on how the model behaves for such records. Then the drifted record management application 114 determines (at block 504) which drifted records are outliers with respect to the model confidence distribution.

To provide an example (shown via reference numeral 506), the machine learning model is trained to predict three classes A, B and C. There is a column City, where a category “Chicago” has 1% records at training time, and 3% records at payload time.

The system plots model confidence for each class A, B, C for City named “Chicago” at training time. The system uses the model confidence of City category “Chicago” at payload time to decide which records to select. In certain embodiments, for City category Chicago, the system selects records where the model confidence of Class A is an outlier with respect to the training model confidence. The system uses mean and standard deviation if the distribution is Gaussian, else the system uses interquartile ranges. The system repeats the above process with other classes, and each record could be an outlier for 0 to 3 classes in an exemplary embodiment. Records are selected based on the number of outlier violations.

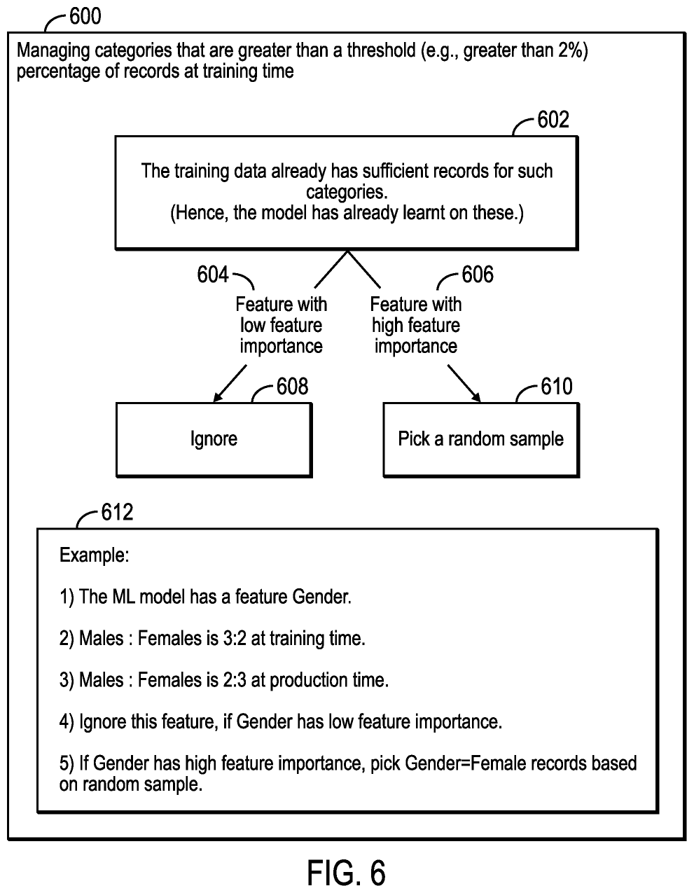

FIG. 6 illustrates a block diagram 600 that shows the managing of categories that are more than a threshold percentage of records at training time, in accordance with certain additional embodiments. The operations shown in FIG. 6 may be performed by the drifted record management application 114 shown in FIG. 1.

FIG. 6 further illustrates embodiments for tackling categories that have greater than a 2% threshold number of records at training time. The training data already has sufficient records for such categories. Hence, the model has already learnt on these (reference numeral 602). For a feature with low feature importance (reference numeral 604), such cases can be ignored (at block 608).

For a feature with high importance (reference numeral 606), it is prudent to select a random sample, where the random sample is selected to balance selected samples (at block 610).

In an example (at block 612), the machine learning model has a feature “Gender”. Males to females ratio is 3:2 at training time, whereas Males to Females ratio is 2:3 at production time. In an exemplary embodiment, the feature is ignored if Gender has low feature importance. However, if Gender has high feature importance, then the system selects Gender equaling Female records, based on random sample.

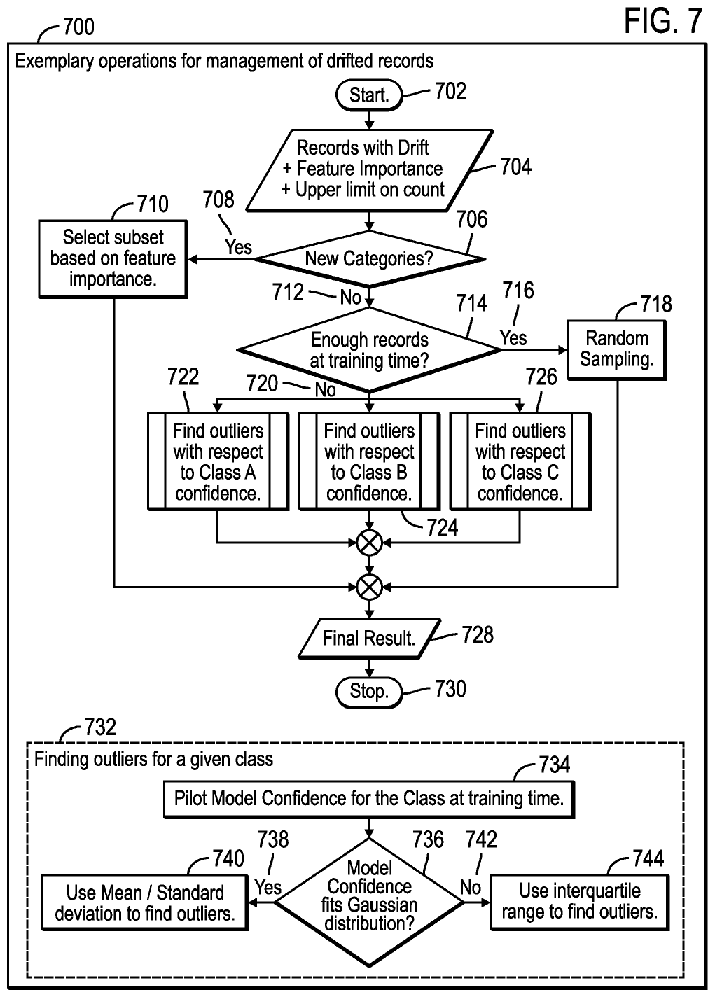

FIG. 7 illustrates a flowchart 700 that shows operations for the management of drifted records, in accordance with certain additional embodiments. The operations shown in FIG. 7 may be performed by the drifted record management application 114 shown in FIG. 1.

Control starts (at block 702), and records with drift are selected (at block 704), where feature importance and upper limit of numbers that can be handled by human users for retraining are certain factors that are considered for selection of records. A determination is made as to whether categories are new (at block 706). If so (“Yes” branch 708) control proceeds to block 710 where a subset based on feature importance is selected.

If the categories are not new (“No” branch 712) then control proceeds to block 714 where a determination is made as to whether there are enough records at training time. If so (“Yes” branch 716) then a random sampling is performed (at block 718). If not (“No” branch 720), then outliers with respect to confidences of exemplary classes (e.g., A, B, C) are determined (reference numeral 722, 724, 726). The final result is determined (at block 728) and the process stops (at block 730).

FIG. 7, also illustrates via a block diagram 732 the process for finding outliers for a given class. The model confidence for the class is plotted at training time (at block 734). A determination is made as to whether the model confidence fits a Gaussian distribution (at block 736). If so (“Yes” branch 738), then mean and standard deviation are used to find outliers (at block 740). If not (“No” branch 742), then outliers are determined (at block 744).

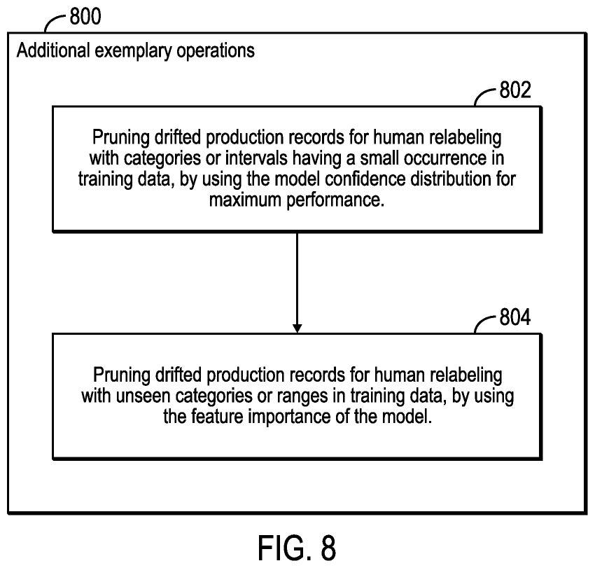

FIG. 8 illustrates a flowchart 800 that shows additional operations for the management of drifted records, in accordance with certain additional embodiments. The operations shown in FIG. 8 may be performed by the drifted record management application 114 shown in FIG. 1.

Control starts at block 802 in which pruning is performed of drifted production records for human relabeling with categories or intervals having a small occurrence in training data by using the model confidence distribution for maximum performance.

From block 802 control proceeds to block 804 in which drifted production records are pruned for human relabeling with unseen categories or ranges in training data using the feature importance of the machine learning model.

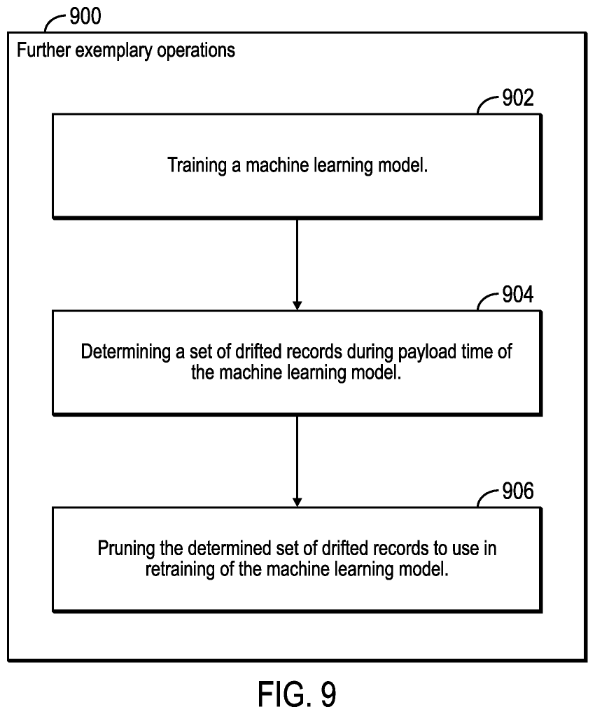

FIG. 9 illustrates a flowchart 900 that shows further operations for the management of drifted records, in accordance with certain additional embodiments. The operations shown in FIG. 9 may be performed by the drifted record management application 114 shown in FIG. 1.

Control starts at block 902 in which a machine learning model is trained. A set of drifted records are determined (at block 904) during payload time of the machine learning model. The determined set of drifted records are pruned (at block 906) to use in retraining of the machine learning model.

Therefore, FIGS. 1-9 illustrate certain embodiments for the management of drifted records in a machine learning environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

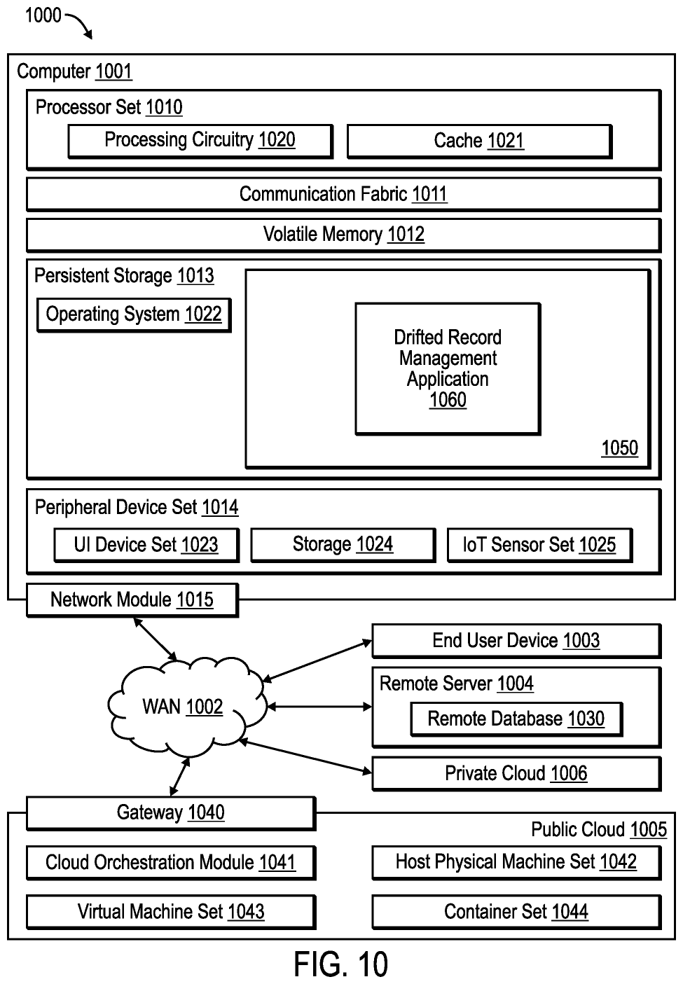

In FIG. 10, computing environment 1000 contains an example of an environment for the execution of at least some of the computer code (block 1050) involved in performing the operations of the drifted record management application 1060 (also shown via reference numeral 114 in FIG. 1).

In addition to block 1050, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1050, as identified above), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1050 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid-state storage devices. Operating system 1022 may take several forms, such as various known proprietary operating systems or open-source Portable Operating System Interface-type operating systems that employ a kernel. The code included in block 1050 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

* IBM, Watson, and OpenScale are trademarks or registered trademarks of International Business Machines Corporation in many jurisdictions worldwide.

What is claimed is:

1. A computer-implemented method, the computer-implemented method comprising:
training a machine learning model;
determining a set of drifted records during payload time of the machine learning model; and
pruning the determined set of drifted records to use in retraining of the machine learning model.

2. The computer-implemented method of claim 1, the computer-implemented method further comprising:
receiving a first record flagged as drifted, the first record belonging to an existing category or interval which has a number of records smaller than a predetermined threshold in a training data of the machine learning model;
obtaining a model confidence distribution for the first record at training time of the machine learning model;
determining whether the first record is an outlier with respect to the model confidence distribution by using a model confidence of the first record at the payload time of the machine learning model; and
outputting the first record as a relabeling candidate based on the determination.

3. The computer-implemented method of claim 2, the computer-implemented method further comprising:
receiving a plurality of second records flagged as drifted, the second records belonging to a new category or interval which is not seen in the training data of the machine learning model;
obtaining a feature importance vector of input features of the machine learning model; and
selecting proportionate number of the second records from each feature, based on the feature importance vector.

4. The computer-implemented method of claim 3, the computer-implemented method further comprising:
receiving a plurality of third records flagged as drifted, the third records belonging to an existing category or interval which has a number of records equal to or greater than the predetermined threshold in the training data of the machine learning model;
obtaining a feature importance vector of input features of the machine learning model; and
selecting or ignoring the third records based on the feature importance vector.

5. The computer-implemented method of claim 1, wherein the set of drifted records result at least from production datasets at payload time having different characteristics from training datasets during the training.

6. The computer-implemented method of claim 1, wherein the set of drifted production records at payload time are pruned for relabeling with categories or intervals having an occurrence less than a predetermined threshold in training data by using a model confidence distribution.

7. The computer-implemented method of claim 1, wherein drifted production records at payload time are pruned for relabeling with unseen categories or ranges in training data by using a feature importance of the machine learning model.

8. A system, comprising:
a memory; and
a processor coupled to the memory, wherein the processor performs operations, the operations comprising:
training a machine learning model;
determining a set of drifted records during payload time of the machine learning model; and
pruning the determined set of drifted records to use in retraining of the machine learning model.

9. The system of claim 8, the operations further comprising:
receiving a first record flagged as drifted, the first record belonging to an existing category or interval which has a number of records smaller than a predetermined threshold in a training data of the machine learning model;
obtaining a model confidence distribution for the first record at training time of the machine learning model;
determining whether the first record is an outlier with respect to the model confidence distribution by using a model confidence of the first record at the payload time of the machine learning model; and
outputting the first record as a relabeling candidate based on the determination.

10. The system of claim 9, the operations further comprising:
receiving a plurality of second records flagged as drifted, the second records belonging to a new category or interval which is not seen in the training data of the machine learning model;
obtaining a feature importance vector of input features of the machine learning model; and
selecting proportionate number of the second records from each feature, based on the feature importance vector.

11. The system of claim 10, the operations further comprising:
receiving a plurality of third records flagged as drifted, the third records belonging to an existing category or interval which has a number of records equal to or greater than the predetermined threshold in the training data of the machine learning model;
obtaining a feature importance vector of input features of the machine learning model; and
selecting or ignoring the third records based on the feature importance vector.

12. The system of claim 8, wherein the set of drifted records result at least from production datasets at payload time having different characteristics from training datasets during the training.

13. The system of claim 8, wherein the set of drifted production records at payload time are pruned for relabeling with categories or intervals having an occurrence less than a predetermined threshold in training data by using a model confidence distribution.

14. The system of claim 8, wherein drifted production records at payload time are pruned for relabeling with unseen categories or ranges in training data by using a feature importance of the machine learning model.

15. A computer program product, the computer program product comprising a computer readable storage medium having computer readable program code embodied therewith, the computer readable program code when executed is configured to perform operations, the operations comprising:
training a machine learning model;
determining a set of drifted records during payload time of the machine learning model; and
pruning the determined set of drifted records to use in retraining of the machine learning model.

16. The computer program product of claim 15, the operations further comprising:
receiving a plurality receiving a first record flagged as drifted, the first record belonging to an existing category or interval which has a number of records smaller than a predetermined threshold in a training data of the machine learning model;
obtaining a model confidence distribution for the first record at training time of the machine learning model;
determining whether the first record is an outlier with respect to the model confidence distribution by using a model confidence of the first record at the payload time of the machine learning model; and
outputting the first record as a relabeling candidate based on the determination.

17. The computer program product of claim 16, the operations further comprising:
receiving a plurality of second records flagged as drifted, the second records belonging to a new category or interval which is not seen in the training data of the machine learning model;
obtaining a feature importance vector of input features of the machine learning model; and
selecting proportionate number of the second records from each feature, based on the feature importance vector.

18. The computer program product of claim 17, the operations further comprising:
receiving a plurality of third records flagged as drifted, the third records belonging to an existing category or interval which has a number of records equal to or greater than the predetermined threshold in the training data of the machine learning model;
obtaining a feature importance vector of input features of the machine learning model; and
selecting or ignoring the third records based on the feature importance vector.

19. The computer program product of claim 15, wherein the set of drifted records result at least from production datasets at payload time having different characteristics from training datasets during the training.

20. The computer program product of claim 15, wherein the set of drifted production records at payload time are pruned for relabeling with categories or intervals having an occurrence less than a predetermined threshold in training data by using a model confidence distribution.
